(19) United States
(12) Patent Application Publication
(10) Pub. No.: US 2009/0011190 A1
(43) Pub. Date: Jan. 8, 2009

(54) Product comprising a protected microstructured area, and a method and a device for producing the same

(75) Inventors: Pekka Koivukunnas, Jarvenpaa (FI); Jani-Mikael Kuusisto, Pirkkala (FI)

Correspondence Address: VENABLE LLP, P.O. BOX 34385, WASHINGTON, DC, 20043-9998, US

(73) Assignee: Avantone Oy, Tampere (FI)

(21) Appl. No.: 11/664,330

(22) PCT Filed: Sep. 28, 2005
(86) PCT No.: PCT/FI05/50331

§ 371 Date: Mar. 24, 2008

(30) Foreign Application Priority Data
Oct. 1, 2004 (FI) 20045369

(51) Int. Cl. B32B 3/30; B41M 1/24

(52) U.S. Cl. 428/167; 428/213; 101/32

(57) ABSTRACT

A bare diffractive microstructured area on a product is protected against wearing by one or more protruding elements. In an embodiment, the product is provided with a depression, whose bottom is further provided with a diffractive microstructured area. Thus, the rim areas of the depression form a protruding element with respect to the microstructured area. If the product is rubbed, for example, against the surface of a table, the protruding element prevents the rubbing surface from having a physical contact with the microstructured area. The microstructured area does not need to be protected with a transparent protective layer, which entails significant cost savings.

The present invention relates to a product comprising a protected diffractive microstructured area produced by embossing. The present invention also relates to a device and a method for manufacturing said product.

### BACKGROUND OF THE INVENTION

Diffractive microstructures may be attached to products e.g. for the visual effect produced by them, or for authenticating the product. Diffractive microstructures may be produced e.g. by embossing on the surface of a substrate, which has been coated with a suitable lacquer. In the embossing process, the coated substrate is pressed between an embossing member and a backing member. The surface of the embossing member comprises a relief corresponding to the microstructure. The backing member supports the substrate from the back side during the embossing process in such a way that the substrate may be subjected to a sufficient pressure, embossing pressure, to shape the surface to comply with the relief of the embossing member. For the shaping of the surface of the substrate, it is advantageous to plasticize the surface by heating. In this context, the temperature of the surface of the substrate during the embossing process is called the embossing temperature, and the pressure exerted on the surface layer of the substrate is called the embossing pressure.

U.S. Pat. No. 4,923,858 discloses a method for producing a diffractive microstructure on the surface of a paper coated with a thermoplastic material. The coating is provided with the microstructure by means of a heated embossing roll.

The height of the embossed patterns on the formed microstructured area is typically the quarter of the wavelength of light, i.e. typically 100 to 200 nanometers. Such a low embossed pattern is easily damaged. When it is desired to protect the produced microstructured area from wearing, the embossed surface is typically covered with a transparent protective layer. Such a method of protection is disclosed, for example, in U.S. Pat. No. 5,756,183.

The protection according to prior art requires means for applying the transparent protective layer to the embossed surface.

Typically, the surface layer of the substrate and the protective layer are made of plastic-like materials whose refractive indices are close to each other. There must be a sufficient difference in the refractive indices of the material of the microstructure and the protective layer in order to make it possible to visually detect the microstructure, which is under the protective layer. For this reason, the microstructured area is typically coated with a thin metal layer before applying the protective layer, which may require, for example, the use of an expensive and slow vacuum deposition method.

U.S. Pat. No. 4,921,319 discloses a hologram in which a diffractive microstructured area is produced on the surface layer of a transparent substrate. The microstructured area is covered with a protective layer, wherein the microstructured area is intended to be viewed through said transparent substrate.

The protection of prior art, implemented with the transparent protective layer, is used as a shield against dirt and wearing caused by foreign objects. However, there are a number of applications in which the protection of prior art, implemented with the transparent protective layer, is excessively strong in view of the intended service life of the product and/or the ambient conditions. Moreover, there are applications in which the protection implemented with the transparent protective layer is too expensive with respect to the price of the product.

### SUMMARY OF THE INVENTION

The main object of the present invention is to make it possible to manufacture a product having a diffractive microstructured area that is resistant to wearing and handling, in such a way that said microstructured area does not need to be covered with a transparent additional layer for protecting the microstructured area.

To attain this purpose, the product, the method and the device according to the invention are primarily characterized in what will be pre-sented in the characterizing part of the appended main claim. The other, dependent claims will present some preferred embodiments of the invention.

To attain this purpose, the product, the method and the device according to the invention are primarily characterized in that the microstructured area is bare, wherein the manufactured product further comprises at least one element protruding with respect to said microstructured area, in order to protect said microstructured area.

The bare microstructure means that said microstructure is visible in at least one direction without a transparent layer between said microstructured area and the viewer.

In one embodiment of the invention, the product is provided with a depression, whose bottom is further provided with a diffractive microstructured area. Thus, the rim areas of the depression constitute a protruding element with respect to said microstructured area. If the product is rubbed, for example, against the surface of a table, said protruding element prevents the surface of the table from damaging the microstructured area.

According to the present invention, it is possible to significantly reduce manufacturing costs, time used for the manufacture and the number of working steps needed. Furthermore, the product according to the invention is environmentally friendlier and easier to recycle, because there is no need to use materials for preparing a protective layer. This is a significant aspect, particularly in the case of e.g. a disposable product.

The invention and its fundamental properties as well as the advantages to be attained by means of the invention will become more evident for a person skilled in the art from the claims and the following description, in which the invention will be described in more detail by means of a few selected examples.

### BRIEF DESCRIPTION OF THE DRAWINGS

FIG. 1a shows schematically the production of a microstructured area on the surface layer of a substrate by means of embossing,

FIG. 1b shows schematically an embossing member, a backing member, and a microstructured area produced on the surface layer of the substrate by embossing,

FIG. 2 shows schematically a microstructured area of prior art, which is metallized and protected with a transparent protective layer,

FIG. 3 shows schematically the protection of a bare microstructured area by means of protruding elements according to the present invention,

FIG. 4 shows schematically an embossing tool, a backing member, and protruding elements made by pressing a compressible substrate,

FIG. 5 shows schematically the production of protruding elements and the microstructured area substantially simultaneously by an embossing member;

FIG. 6 shows by way of example the relative thickness of a compressible substrate as a function of the embossing pressure,

FIG. 7 shows schematically the production of protruding elements by causing material flow in the surface layer,

FIG. 8 shows schematically the production of protruding elements by means of recesses in the embossing member,

FIG. 9 shows schematically the production of protruding elements by means of recesses in the embossing member and bulges in the backing member,

FIG. 10 shows an embossing device according to the present invention,

FIG. 11 shows schematically protruding elements formed of an additional material on the surface layer of the substrate,

FIG. 12 shows by way of example a microstructured area flanked by a single solid protruding element,

FIG. 13 shows by way of example a microstructured area protected by a group of spot-like protruding elements, some of the elements being located on said microstructured area,

FIG. 14 shows by way of example a microstructured area protected by a group of linear protruding elements, and

FIG. 15 shows schematically a product having a microstructured area, which is protected according to the invention.

### DETAILED DESCRIPTION OF THE INVENTION

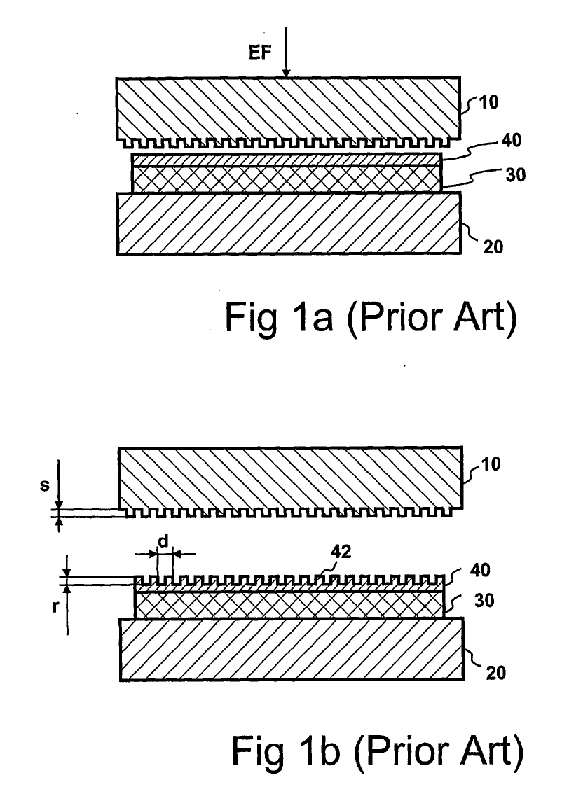

With reference to FIG. 1a, an embossing force EF is exerted on an embossing member 10. Furthermore, the surface of the embossing member exerts a corresponding embossing pressure on the surface layer 40 of the substrate 30, local i.e. spatial differences in the embossing pressure causing local material flow and/or compression in the surface layer 40, wherein the surface layer 40 is shaped to, correspond to the relief of the surface of the embossing member 10. During the embossing procedure, the substrate 30 is supported by means of a backing member 20. The substrate 30 may be, for example, paper, cardboard or plastic. The surface layer 40 may consist of, for example, a thermoplastic material, such as a polyvinyl chloride or polycarbonate plastic, whose viscosity is reduced at a high temperature. Examples of such materials are listed in U.S. Pat. No. 4,923,858. The surface layer 40 may also consist of an epoxy resin or a UV curable lacquer. The microstructure may also be embossed on printing ink as disclosed in U.S. Pat. No. 5,873,305. The substrate 30 and its surface layer 40 may also consist of the same material.

Typically, the surface of the embossing member 10 has e.g. a shim made of a nickel-based material, and which shim is provided by optical and electrolytic methods with reliefs corresponding to the desired microstructure. A method for manufacturing the shim with the relief suitable for use on the surface of the embossing member 10 is described, for example, in U.S. Pat. No. 3,950,839. The embossing member 10 may also be manufactured by methods of electron beam litography.

The surface of the backing member 20 may consist of a metal. To compensate for the roughness of the surfaces, the surface of the backing member 20 may also be resilient, wherein said surface may consist of, for example, epoxy resin or rubber.

FIG. 1b shows a diffractive microstructure produced on the surface layer 40 of a substrate 30 by the method according to FIG. 1a. The shape of the surface of the diffractive microstructured area 42 embossed on the surface layer 40 corresponds to the shape of the surface of the embossing member 10. The structure is periodical in such a manner that substantially the same shape recurs on the surface in at least one direction at intervals of a so-called grating constant d. It is clear for a person skilled in the art that the value of the grating constant and the orientation of the shapes may vary at different locations of the surface, wherein the desired diffractive effect or holographic pattern is obtained. Said shape may be, for example, binary, i.e. rectangular, as shown schematically in the appended drawings. However, the shape may also be, for example, sinusoidal or triangular. The pattern height r of the produced microstructure is typically in the order of the quarter of the wavelength of light, that is, in the range of 100 to 200 nanometers. However, the pattern height r may be considerably lower than 100 nm, in which case the microstructured area produces a visually weak effect. The pattern height r may also be higher than 200 nm, in which case the wear resistance of the microstructured area 42 is improved to some extent.

The pattern height r of the microstructured area is smaller than or equal to the pattern height s of the surface of the embossing member 10. If the embossing pressure and/or the embossing temperature is low, the pattern height r of the microstructured area remains significantly lower than the pattern height s on the surface of the embossing member 10.

The surface layer 40 may comprise several zones covered with a similar or different diffractive microstructure to provide a desired colour effect, motion effect, two-dimensional pattern, pattern depending on the direction of viewing, animation, pattern providing a three-dimensional impression, or visually invisible microstructure. A part of the surface layer 40 may be left unembossed. The substrate 30 or its surface layer 40 may also comprise patterns or symbols produced with a dye. These may be produced before, simultaneously with or also after the embossing. The patterns provided with a dye and the produced microstructures may overlap in whole or in part. The embossed microstructured area 42 may be coated with a metal film to enhance the visual effect. Instead of the metal film, it is also possible to use transparent materials having a high refractive index, such as zinc sulphide.

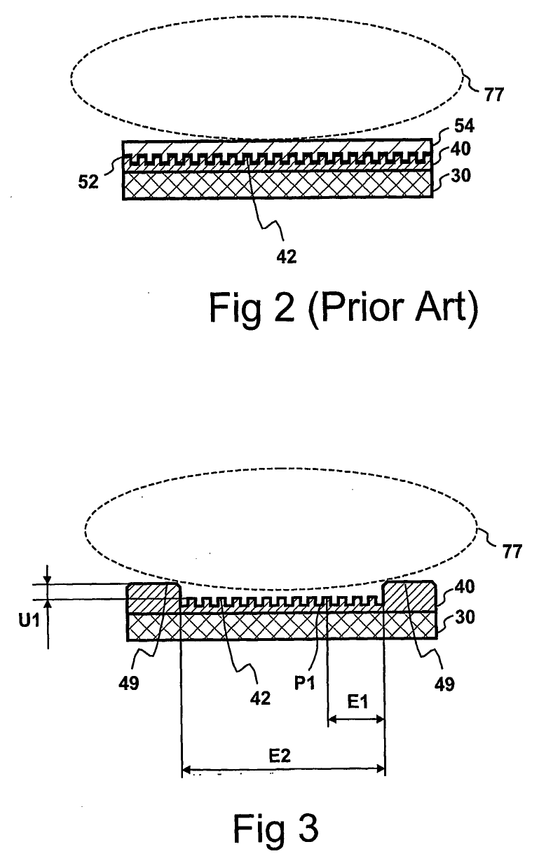

FIG. 2 shows a method of prior art for protecting a microstructured area 42. The microstructured area 42 is coated with a thin optically reflective metal film 52 to enhance the visual effect, wherein also said metal film 52 has the embossed microstructured area 42. The microstructured area 42 of the metal film 52 is protected with a transparent protective layer 54 against wearing by a foreign object 77. Consequently, in the protecting method of prior art shown in FIG. 2, the transparent protective layer 54 is provided between the metallized microstructured area 42 and the viewer.

FIG. 3 shows the protection of microstructured areas 42 according to the present invention. A bare diffractive microstructured area 42 is produced on the surface layer 40 of the substrate 30 by embossing. At least one protruding element 49 is arranged to protect said microstructured area 42.

The microstructured area 42 refers to an area with a diffractive microstructure.

The microstructured area 42 according to the present invention is bare, which means that said microstructured area 42 is visible in at least one direction without a transparent protective layer between said microstructured area 42 and the viewer. As there is no protective layer, the embossed patterns of the diffractive microstructure of the bare microstructured area 42 produced on the surface layer 40 of the substrate 30 are bordered by air.

According to the invention, at least one protruding element 49 is arranged to protrude with respect to the level of the surface of the protected microstructured area 42. In FIG. 3, the protrusion of the protruding element 49 in relation to the level of the surface of the microstructured area 42 is U1. E2 refers to the distance between two protruding elements 49. P1 refers to a arbitrary point in the microstructured area 42. E1 is the distance between the arbitrary point P1 in the microstructured area 42 and the closest protruding element 49.

The protruding elements 49 protect the microstructured area 42 against a wearing or scratching effect by a foreign object 77. The foreign object may be, for example, the surface of a table.

The protective effect of the protruding elements 49 is based on the fact that they prevent the physical contact between the microstructured area 42 and the foreign object 77. The protective effect becomes stronger as the protrusion U1 of the elements 49 increases. If there are two or more elements 49, and the microstructured area 42 is between them, the protective effect becomes stronger as the distance E2 between the elements 49 decreases. The protective effect becomes stronger as the distance E1 between the point P1 of the protected microstructured area 42 and the element 49 is reduced. If the surface of the foreign, object 77 is convex, a more effective protection is required than in the case in which the surface of the foreign object 77 is planar.

It has been found that for protecting the microstructured area 42 against wearing caused by planar or slightly convex foreign objects 77, it will be sufficient to use low protruding elements 49. In this context, the low protruding element means that the protrusion U1 of the element 49 in relation to the protected microstructured area 42 is in the range of 0.05 to 0.3 millimeters. The planar or slightly convex foreign object 77 may be, for example, the surface of a table or the surface of a sheet of paper.

The ratio between the protrusion U1 of the element 49 and the distance E1 is advantageously greater than or equal to 0.03. If the protrusion U1 is equal to 0.3 mm, in the case of one protruding element 49 it is advantageous that the microstructured area 42 does not extend farther than 10 mm from the protruding element 49. Respectively, in the case of at least two elements 49, the distance E2 between the two elements 49 shall be smaller than or equal to 20 mm to protect the microstructured area 42 therebetween, the protrusion U1 being 0.3 mm.

If the protrusion U1 is higher than 0.3 mm, a stronger protection is achieved and/or the distances E1 and E2 may be increased. However, it may be difficult to increase the protrusion, particularly when the structure formed by the substrate 30 and its surface layer 40 is thin.

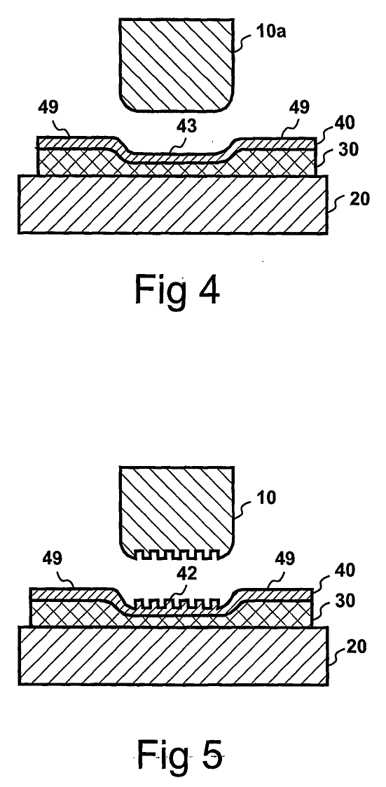

With reference to FIG. 4, in the most preferred embodiment, the microstructured area 42 to be protected is located on a depression formed in the surface layer 40. The protruding elements 40 may be produced, for example, by pressing the substrate 30 and its surface layer 40 with a pressing tool 10a to form the depression 43. The areas left elevated on the surface layer 40 constitute the elements 49, which protrude with respect to said depression 43. The situation of FIG. 4 requires that the substrate 30 and/or its surface layer 40 are compressible. An example of a compressible substrate 30 is cardboard.

To prevent the cutting of the substrate 30 and/or its surface layer, it is advantageous that the edges of the pressing tool 10a are rounded or at least beveled.

With reference to FIG. 5, the embossing member 10 producing the microstructured area 42 is advantageously used as the pressing tool 10a mentioned in connection with FIG. 4. Consequently, the protruding elements 49 and the microstructured area 42 in the depression 43 are formed simultaneously or almost simultaneously by a single unidirectional movement of the embossing member 10.

Thus, the surface of the embossing member 10 comprises a section that is used both as the embossing surface and as a surface compressing the structure macroscopically.

The depth of the depression 43 produced by pressing, and thus the protrusion U1 of the protruding element 49, depends on the exerted compressing pressure, that is, in the situation of FIG. 5, on the embossing pressure p_{E}.

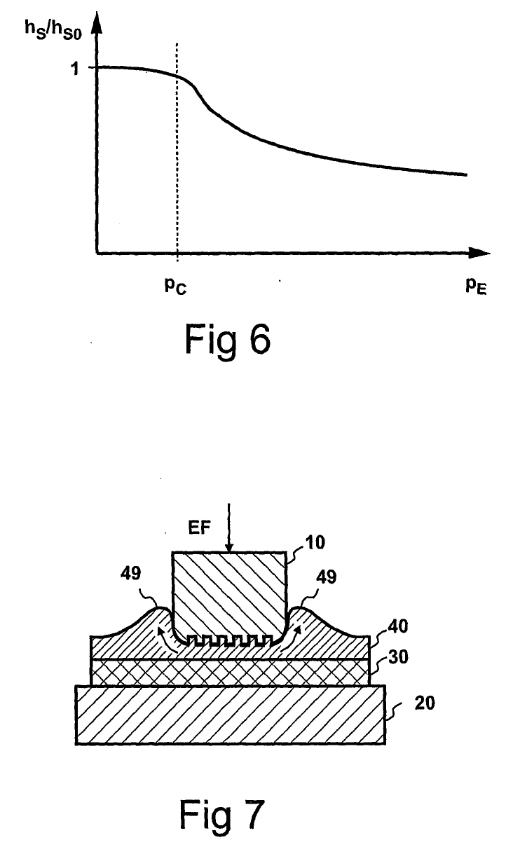

FIG. 6 shows by way of example the relative thickness h_{S}/h_{S0} of the structure formed by the substrate 30 and its surface layer 40 as a function of the embossing pressure p_{E}. h_{S} is the thickness of the structure formed by the substrate 30 and its surface layer 40, and h₅₀ is the initial thickness of the structure formed by the substrate 30 and its surface layer 40. Typically, a threshold value P_{C} of the embossing pressure must be exceeded until the structure begins to be significantly compressed.

The thickness h_{S} of the structure formed by the substrate 30 and its surface layer 40 may be, after pressing at a predetermined temperature by using a predetermined embossing pressure value, for example 80% of the initial thickness h_{S0} of said structure. The relative compression of the structure is 20%, respectively. For example, when pressing a coated cardboard having a thickness of 1 mm, the thickness after the pressing may be e.g. 0.8 mm and the protrusion of the produced element 49 may be 0.2 mm.

Also, the pattern height r of the produced microstructured area 42 and simultaneously the strength of the produced effect depends on the embossing pressure p_{E}. The temperature also affects the relative thickness h_{S}/h_{S0} and the pattern height r. When the microstructured area 42 and the protruding elements 49 are produced simultaneously or almost simultaneously, for example according to FIG. 5, the material of the substrate 30, the material of the surface layer 40, the temperature of the substrate 30, the embossing temperature, and the embossing pressure p_{E} are selected so as to produce the desired protrusion U1 and the desired pattern height r of the microstructure.

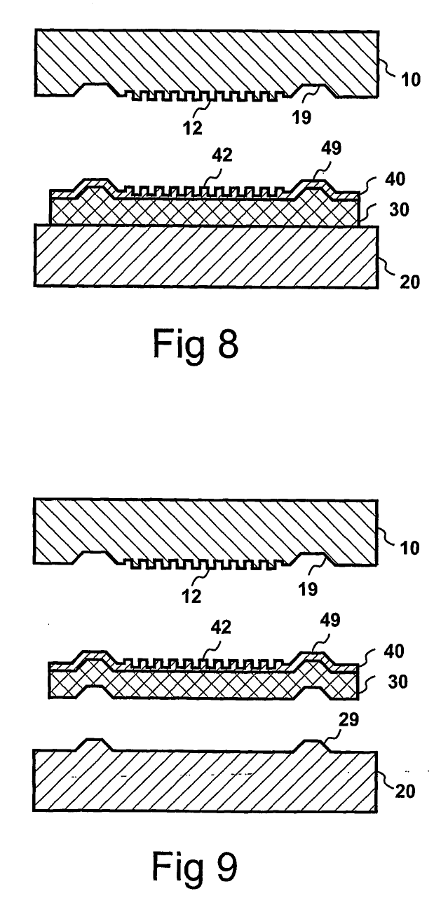

FIG. 7 shows a situation in which the embossing member 10 is pressed against the surface layer 40 by a force EF, wherein the material of the surface layer 40 flows away from below the embossing member 10, forming one or more protruding elements 49. The situation of FIG. 8 requires that the surface layer 40 has been sufficiently plasticized. The surface layer is advantageously heated to the so-called glass transition temperature or to a higher temperature. The protruding elements 49 may also rise higher than the initial level of the surface layer 40.

With reference to FIG. 8, the protruding elements 49 may also be produced by means of recesses 19 in the embossing member 10. By pressing with the embossing member 10, a compression and/or flow of the substrate 30 and/or its surface layer 40 is caused to form the protruding elements 49 at locations corresponding to said recesses 19.

With reference to FIG. 9, the formation of the protruding elements 49 may be boosted if the backing member 20 also comprises bulges 29. The bulges 29 push the substrate 30 from below during the embossing, thereby contributing to the formation of the protruding elements 49.

In an embodiment, the embossing member 10 may comprise, at locations corresponding to the produced protruding elements 49, a resilient surface that is flat in the resting state and which is made of, for example, rubber. When the substrate 30 underneath the embossing member 10 is pushed by the backing member 20 having bulges 29, then corresponding recesses 19 are temporarily formed on the surface of the embossing member 10 during the embossing.

Alternatively, the surface of the backing member 20 may be covered with a resilient material throughout, wherein the surface of the backing member 20 is flat in the resting state. When the substrate 30 placed on said backing member 20 is pressed by the embossing member 10 having the recesses 19, then corresponding bulges 29 are temporarily formed on the surface of the backing member 20 during the embossing procedure.

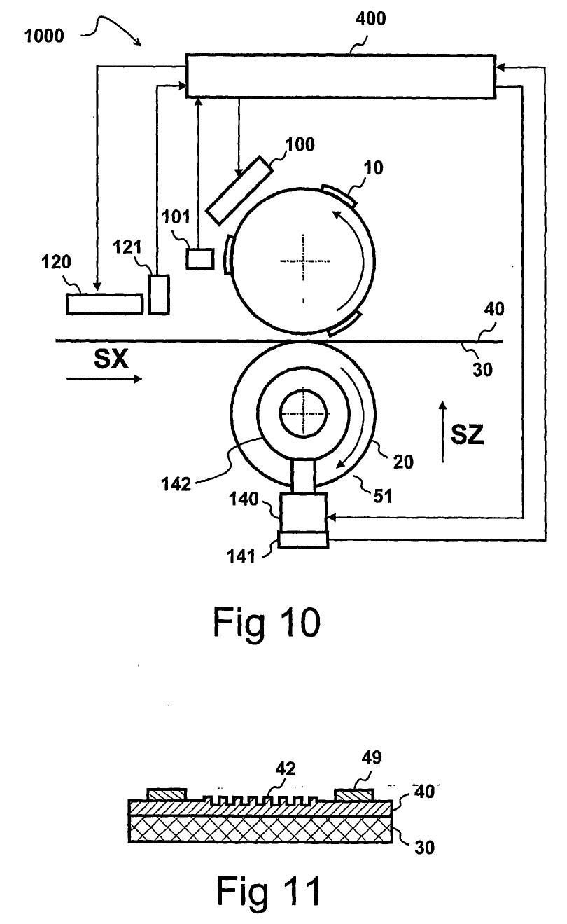

FIG. 10 shows an embossing device 1000 according to the present invention, in which the embossing member 10 and the backing member 20 are rotating rolls. The backing roll 20 is pressed against the embossing roll 10 in the direction SZ. The embossing roll 10 and the backing roll 20 are rotated by rotating mechanisms. Thus, the substrate 30 moves in the direction SX and is pressed between the embossing roll 10 and the backing roll 20.

The surface of the embossing roll 10 comprises elevated sections for producing microstructured areas 42, which sections produce microstructured areas 42 and protruding elements 49.

The embossing pressure exerted by the embossing roll 10 and the backing roll 20 on the surface layer 40 of the substrate is adjusted by means of two actuators 140 attached to the bearings 142 of the backing roll 20, which actuator may be for example hydraulic or pneumatic cylinders. The actuators 140 may also be mechanical or electromechanical force generating devices. The actuators 140 may also be manually adjustable. In connection with the cylinders 140 there are sensors 141 monitoring the embossing force, i.e. indirectly the embossing pressure as well.

It is advantageous to limit the smallest distance between the embossing roll 10 and the backing roll 20 mechanically in such a way that no significant pressure is exerted on the surface layer 40 of the substrate when the embossing roll 10 is in such a position that it does not produce a microstructured area 42.

An alternative way is to adjust the force generated by the actuators 140 according to the width of the contact surface between the embossing roll 10 and the produced microstructured areas 42 at each moment of time.

The embossing temperature may be controlled by adjusting the power of infrared heaters 120 heating the surface layer 40 of the substrate 30 and/or by adjusting the power of inductive elements 100 heating the embossing member 10. The temperatures are monitored, for example, by pyrometric measuring devices 101, 121.

The heating of the embossing roll 10 may also be based on a heat transfer medium, such as oil, circulating inside the roll 10. The embossing device 1000 may also comprise inductive heaters 100 or auxiliary rolls heated by electricity or by a heat transfer medium. The embossing roll may comprise thermoelements and pressure sensors for monitoring the pressure and the temperature.

The control unit 400 adjusts the values of the temperatures, pressure and the rotating speed of the rolls at least on the basis of measuring signals from sensors 101, 121 and 141. When required, the control unit 400 also communicates with other simultaneous processes, such as a printing process or a coating process, to achieve problem-free cooperation.

Furthermore, the adjustment of the embossing device 1000 may also be manual so that the user of the embossing device 1000 watches a display to monitor the signals of the measuring devices 121, 101, 141, or the values of parameters computed from the signals, and performs the necessary control operations manually.

In the embodiments of FIGS. 3 to 11, the protruding elements 49 are at least partly formed of the same material of the surface layer 40 as on which the microstructured area 42 is implemented. FIG. 11 shows an alternative embodiment in which the protruding elements 49 consist of an additional material applied to the surface layer 40 of the substrate. The additional material may be, for example, a cardboard or a plastic laminated onto the surface layer 40. The additional material may also be lacquer or a castable plastic. The additional material may also consist of the same chemical material as the surface layer 40.

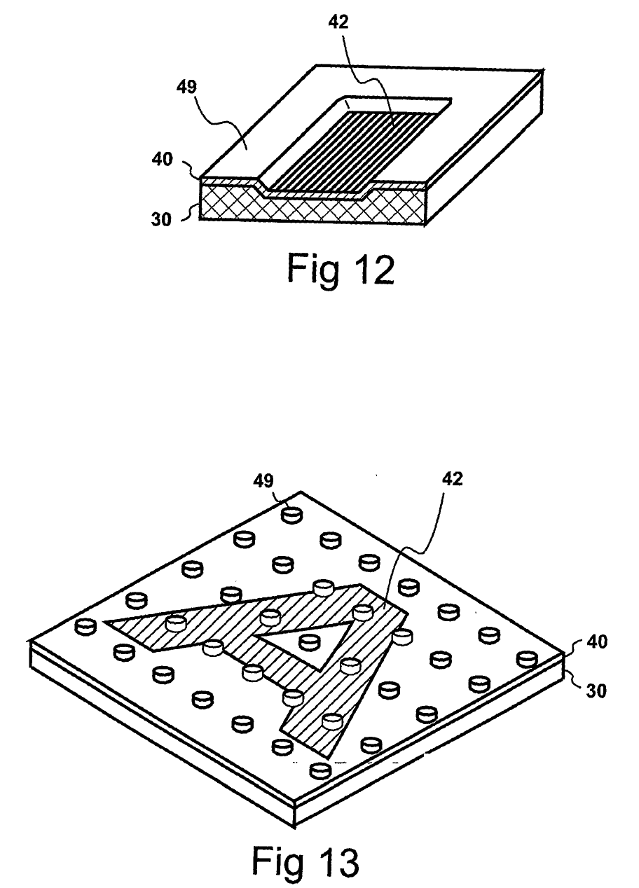

With reference to FIG. 12, the protruding element 49 may consist of the surface layer 40 of the substrate 30 in such a way that said protruding element 49 surrounds or flanks the microstructured area 42. FIG. 12 shows an example of a situation in which the microstructured area 42 is protected by only one protruding element 49. The microstructured area 42 of FIG. 12 may be produced, for example, on a depression formed in a coated cardboard having a thickness of 0.3 mm, the depth of the depression being e.g. 0.1 mm. The microstructured area 42 according to the present invention is advantageously produced in a low depression, wherein the low depression means that the depth of said depression in relation to the initial level of the surface layer 40 is in the range of 0.05 to 0.3 mm.

However, if the total thickness of the substrate 30 and its surface layer 40 is low, it may be difficult or impossible to implement a depression having a thickness of 0.05 to 0.3 mm. On the other hand, if the total thickness of the substrate 30 and its surface layer 40 is high, for example in the case of implementing the microstructured area 42 on a massive piece of plastic, the depression may be significantly deeper than 0.3 mm. In general, the protrusion of the protruding element 49 in relation to the level of the microstructured area 42 is advantageously in the range of 5 to 35% of the total thickness of the substrate 30 and its surface layer 40.

With reference to FIG. 13, the protruding elements 49 protecting the microstructured area 42 may have, for example, a spot-like shape. In FIG. 13, the microstructured area 42 has the shape of the letter “A”. The protruding elements 49 may also be located in the microstructured area 42. Consequently, the single protruding element 49 may be surrounded by the microstructured area 42. The single protruding element 49 may also be flanked by the microstructured area 49 in one or more directions.

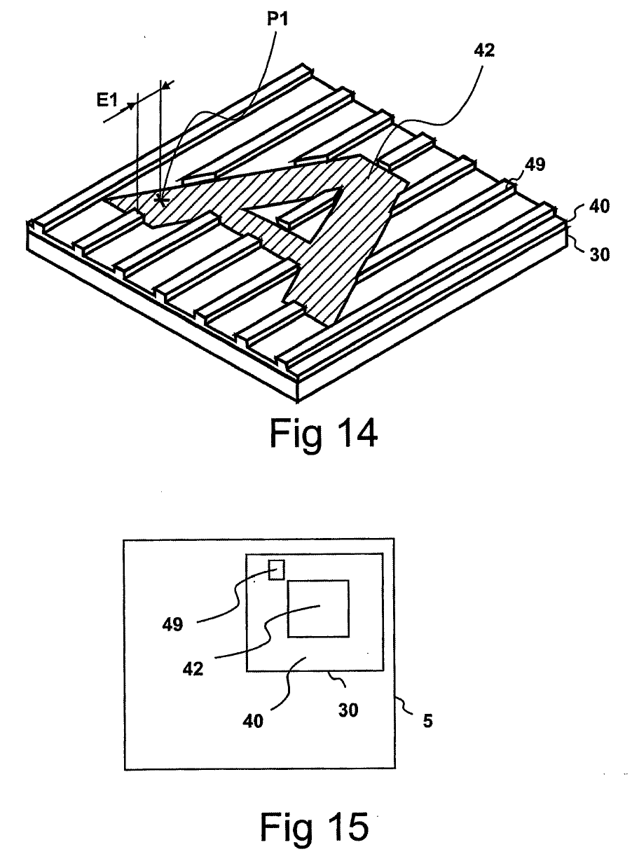

With reference to FIG. 14, the protruding elements 49 may also be straight or curved ribs. The visual effect produced by the microstructured area 42 is more harmonious, when there are no protruding elements 49 in the microstructured area 42.

FIG. 14 also shows the distance E1 between a random point P1 in the microstructured area 42 and the protruding element 49 closest to said point P1. The distance between the point P1 and the closest protruding element 49 is advantageously smaller than or equal to the height of said protruding element 49 divided by the number 0.03.

The protruding elements 49 may also be joined to each other by forming, for example, a mesh-like pattern to protect the microstructured area 42 (not shown).

With reference to FIG. 15, the product 5 according to the present invention comprises at least a substrate 30, the surface layer 40 of the substrate, at least one microstructured area 42 produced on the surface layer, and at least one element 49 protruding with respect to said microstructured area 42. The product 5, the substrate 30 and the surface layer 40 may also consist completely of the same material, for example of plastic.

The substrate 30 and its surface layer 40 are advantageously made of a flexible material, and their total thickness is advantageously in the range of 0.05 to 3 mm. However, the substrate 30 may also be a thick piece of plastic, for example having a thickness of 50 mm, which may further contain for example electronic components.

The bare microstructured area 42 protected with a protruding element according to the present invention may be advantageously used, for example, in products 5 intended to be disposable, in which products the microstructured area 42 is required to be intact for only a relatively short time. The protected microstructured area according to the invention is also advantageous in products 5 which are subjected to wearing caused substantially by only planar or slightly convex foreign objects 77.

The product 5 may be, for example, an object having a plastic surface and comprising the diffractive microstructured area 42 to attract the interest of a potential customer or to authenticate the product. The product 5 may be a part of a device equipped with wireless communication means, for example a battery for a mobile phone.

The product 5 may also be, for example, a product brochure comprising a diffractive microstructured area 42 producing a visual effect to attract the interest of a customer. Said brochure may consist of, for example, lacquered paper. Said product brochure may also comprise images and text produced by conventional printing techniques. It is important to be able to store and transport the product brochures stacked on top of each other in such a way that the microstructured area 42 is of first-class quality when delivered to the customer. It is probable that said product brochures will, at some stage, be rubbed against each other, or for example against the surface of a table, wherein it is advantageous to protect the microstructured areas 42 of the product brochures with one or more protruding elements 49 according to the invention.

The product 5 may also be e.g. a product package whose surface comprises a diffractive microstructured area 42 producing a visual effect. Thus, the absence of said microstructured area 42 from the package indicates the possibility of a counterfeit product.

Advantageously, the microstructured area 42 of the product 5 contains only non-metallic material, which means that the surface layer 40 of the substrate 30 does not contain metal, and the microstructured area 42 is not coated with a thin metal layer 52 either. Thus, the product 5 is less expensive and cheaper to manufacture than a product equipped with the transparent protective layer. The product 5 is also environmentally friendlier, because no materials or processes for the protective layer or a metallization will be needed. The environmental friendliness and/or recyclability is a significant aspect particularly in products intended to be disposable.

The visual effect produced by the microstructured area 42 attached to the product 5 may also be transparent, wherein transparency means that there is at least one direction, in which the visual effect caused by diffracted light is not detected. Thus, graphic characters produced on the substrate 30 or on the surface layer 40 by printing methods can be viewed in said at least one direction without disturbance by the diffractive effect. If the substrate 30 and the surface layer 40 are substantially transparent, it is possible to view an object behind the substrate 30, for example an article in a package, in said at least one direction without the disturbance by the diffractive effect.

The protruding elements 49 may be formed before the forming of the microstructured area 42, substantially simultaneously with the forming of the microstructured area 42, or after the forming of the microstructured area 42. The microstructured area 42 and the protruding elements 49 may be formed with the same tool or with different tools. The protruding elements 49 may be formed by shaping a surface on which the microstructure has been produced in advance. The previously produced protruding elements 49 may also be leveled out, and a microstructure may be produced at their location. Also, the protruding elements 49 may contain a part of the diffractive microstructure.

The invention is not limited solely to the embodiments presented in the above description and in the drawings. The aim is to limit the invention only by the presentation of the scope of the appended claims.

1-32. (canceled)

33. A product, comprising:
at least one substrate;
at least one protected diffractive microstructured area, which microstructured area has been produced on the surface layer of said substrate by embossing, wherein said microstructured area is bare; and
at least one element that protrudes with respect to said microstructured area in order to protect said microstructured area, wherein any point of said microstructured area is protected by a protecting protruding element such that the amount of protrusion of said protecting protruding element is greater than or equal to a distance between said any point and said protecting protruding element multiplied by a factor of 0.03.

34. The product according to claim 33, wherein at least one of said at least one protruding element has been formed by pressing a depression in said surface layer.

35. The product according to claim 33, wherein said microstructure is located on a depression in said surface layer.

36. The product according to claim 35, wherein said depression in the surface layer has been formed at least partly by pressing with an embossing member.

37. The product according to claim 33, wherein at least one of said at least one protruding element is a bulge or a group of bulges.

38. The product according to claim 33, wherein at least one of said at least one protruding element is a rib or a pattern formed of ribs.

39. The product according to claim 33, wherein at least one of said at least one protruding element is surrounded by a diffractive microstructure.

40. The product according to claim 33, wherein at least one of said at least one protruding element has been formed of an additional material introduced to said surface layer.

41. The product according to claim 33, wherein the amount of protrusion of at least one of said at least one protruding element with respect to the level of the microstructured area is in the range of 0.05 to 0.3 millimeters.

42. The product according to claim 33, wherein the amount of protrusion of at least one of said at least one protruding element with respect to the level of the microstructured area is in the range of 5 to 35% of the total thickness of the substrate and its surface layer.

43. The product according to claim 33, wherein said product is a part of a device equipped with wireless communication means.

44. A device for manufacturing a product, comprising:
a protected diffractive microstructured area, which product comprises at least a substrate and a microstructured area produced on the surface layer of said substrate by embossing, wherein said device is arranged to produce at least one bare microstructured area by embossing on said surface layer, and to produce at least one element which protrudes with respect to said microstructured area, wherein said at least one protruding element is arranged to be produced such that any point of said microstructured area is protected by a protecting protruding element, wherein the amount of protrusion of said protruding element is greater than or equal to a distance between said any point and said protecting protruding element multiplied by a factor of 0.03.

45. The device according to claim 44, further comprising:
means for producing a depression in the surface layer of said substrate, wherein at least one rim area of said depression forms said protruding element.

46. The device according to claim 45, further comprising:
means for embossing said microstructured area on said depression.

47. The device according to claim 45, further comprising:
an embossing member, which is arranged to produce said microstructured area and said depression.

48. The device according to claim 44, wherein said protruding element is a bulge.

49. The device according to claim 44, wherein said protruding element is a rib or a pattern formed by ribs.

50. The device according to claim 44, wherein said protruding element and said microstructured area are arranged to be produced in such a way that said protruding element is flanked or surrounded by said microstructured area.

51. The device according to claim 44, further comprising:
means for forming said protruding element of an additional material introduced to said surface layer.

52. The device according to claim 44, wherein said protruding element and said microstructured area are arranged to be produced in such a way that the amount of protrusion of at least one of said at least one protruding element with respect to the level of the microstructured area is in the range of 0.05 to 0.3 millimeters.

53. The device according to claim 44, wherein said protruding element and said microstructured area are arranged to be produced in such a way that the amount of protrusion of at least one or said at least one protruding element with respect to the level of the microstructured area is in the range of 5 to 35% of the total thickness of the substrate and its surface layer.

54. A method for producing a product comprising a protected diffractive microstructured area, which product comprises at least a substrate and a microstructured area produced on the surface layer of said substrate by embossing, the method comprising:
producing at least one bare microstructured area by embossing on said surface layer;
producing at least one element which protrudes with respect to said microstructured area; and
selecting the amount/amounts of protrusion of said at least one element such that any point of said microstructured area is protected by a protecting protruding element, wherein the amount of protrusion of said protecting protruding element is greater than or equal to a distance between said any point and said protecting protruding element multiplied by a factor of 0.03.

55. The method according to claim 54, wherein at least one of said at least one protruding element is formed by pressing a depression in said surface layer.

56. The method according to claim 55, wherein said microstructure is produced on the depression in said surface layer.

57. The method according to claim 55, wherein the depression is produced at such a location on said surface layer where there is a microstructured area.

58. The method according to claim 23, wherein the depression and said microstructured area are formed on said surface layer substantially simultaneously by pressing with an embossing member.

59. The method according to claim 54, wherein at least one of said at least one protruding element is a bulge.

60. The method according to claim 54, wherein at least one of said at least one protruding element is a rib or a pattern formed of ribs.

61. The method according to claim 54, wherein said protruding element and said microstructured area are produced in such a way that said protruding element is flanked or surrounded by said microstructured area.

62. The method according to claim 54, wherein at least one of said at least one protruding element is formed of additional material introduced to the surface layer.

63. The method according to claim 54, wherein the amount of protrusion of at least one of said at least one protruding element with respect to the level of the microstructured area is in the range of 0.05 to 0.3 millimeters.

64. The method according to claim 54, wherein said protruding element and said microstructured area are produced in such a way that the amount of protrusion of at least one of said at least one protruding element with respect to the level of the microstructured area is in the range of 5 to 35% of the total thickness of the substrate and its surface layer.
